(19) United States
(12) Patent Application Publication
(10) Pub. No.: US 2008/0123833 A1
(43) Pub. Date: May 29, 2008

(54) TELEPHONE SYSTEM AND CALL CONTROLLING METHOD THEREFOR

(75) Inventor: Masahiko HARA, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/839,659

(22) Filed: Aug. 16, 2007

(30) Foreign Application Priority Data
Nov. 28, 2006 (JP) 2006-320346

(51) Int. Cl. H04M 7/00

(52) U.S. Cl. 379/219

(57) ABSTRACT

According to one embodiment, there is provided a telephone system including a plurality of exchanges interconnecting a private network each exchange including a plurality of communicating terminals and giving a local identifier to a call relative to each communication terminal belonging to each exchange; a call control application unit configured to control the call based on the local identifier; an identifier giving processing unit configured to give a global identifier commonly used among the plurality of exchanges to each call set among different exchanges through the private network; a conversion processing unit configured to convert the global identifier into the local identifier recognizable by the call control application unit; and a relay processing unit configured to give the converted local identifier to the call control application unit and enable the call control application unit to control a call having the global identifier based on the converted local identifier.

### CROSS-REFERENCE TO RELATED APPLICATIONS

This application is based upon and claims the benefit of priority from Japanese Patent Application No. 2006-320346, filed on Nov. 28, 2006, the entire contents of which are incorporated herein by reference.

### BACKGROUND

1. Field

One embodiment of the invention relates to a telephone system employed as e.g. a call center and its call controlling method.

2. Description of the Related Art

There is a well-known system communicating audio information through a best-effort type communication network such as the internet. The kind of system is called an IP telephone system or VoIP (Voice over IP) and applied to a local communication network such an local area telephone network as well as a wide area telephone network. The telephone terminal in this kind of system is also called an IP telephone set.

There is further well-known system receiving telephone calls from an definite number of customers and distributing the telephone calls to plural telephone sets of operators. Such a kind of system is called a call center and located in a “customer advice room”. The system has an automatic call distribution (ACD) function for averaging the operators' burden by equally receiving calls on the telephone sets during their log-in.

Meanwhile, there is a telephone system in which plural exchanges (PBXs (Private Branch eXchanges)) are connected through a dedicated communication network (private network) using IP technology. Such a telephone system permits mutual communication to be done not via a public network and so is good in cost. In this kind of system, when a call occurs, the individual call for each exchange is managed by an individual call identifier (Call ID). Namely, each call is managed in each exchange. In order to use the ACD in this format, a function capable of dealing with plural identifiers recognized for the same call as a single call is mounted on a server device. This is not preferable because the labor and cost for developing application software are huge.

It is disclosed by, for example JP-A-2005-323387 and JP-A-2005-295592, that a plurality of PBXs are connected to a call center function server so that calls can be distributed to the receivers connected to the plurality of PBXs. However, the technique relative to the calls among the PBXs is not disclosed and only the call distribution to the receivers is disclosed. This cannot solve the inconvenience described above.

It is disclosed by, for example JP-A-2001-86244, that the call distribution to the receivers at a remote office is disclosed, but the receivers at the remote office are directly connected to the PBXs through the network. This reference also does not disclose the call control among different PBXs.

It is disclosed by, for example JP-A-2000-174907, that the call distribution for the receivers connected to the plurality of PBXs and their unified management. However, a public network is employed for the call distribution among the PBX where the receiver exists and a main PBX (call distribution management). Therefore, in the PBX where the receiver exists, the call is dealt with as the call from the public network. Thus, the call in each PBX cannot be managed nor controlled by the unified ACD so that the above inconvenience cannot be solved.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary system diagram showing a telephone system according to an embodiment;

FIG. 2 is an exemplary flowchart for explaining the processing procedure in numbering the global call ID in the PBX in FIG. 1; and

FIG. 3 is an exemplary flowchart for explaining the processing procedure in converting the call ID in the relay software 12 in FIG. 1.

### DETAILED DESCRIPTION

Various embodiments according to the invention will be described hereinafter with reference to the accompanying drawings. In general, according to one embodiment of the invention, there is provided a telephone system including a plurality of exchanges interconnecting a private network each exchange including a plurality of communicating terminals and giving a local identifier to a call relative to each communication terminal. belonging to each exchange; a call control application unit configured to control the call based on the local identifier; an identifier giving processing unit configured to give a global identifier commonly used among the plurality of exchanges to each call set among different exchanges through the private network; a conversion processing unit configured to convert the global identifier into the local identifier recognizable by the call control application unit; and a relay processing unit configured to give the converted local identifier to the call control application unit and enable the call control application unit to control a call having the global identifier based on the converted local identifier.

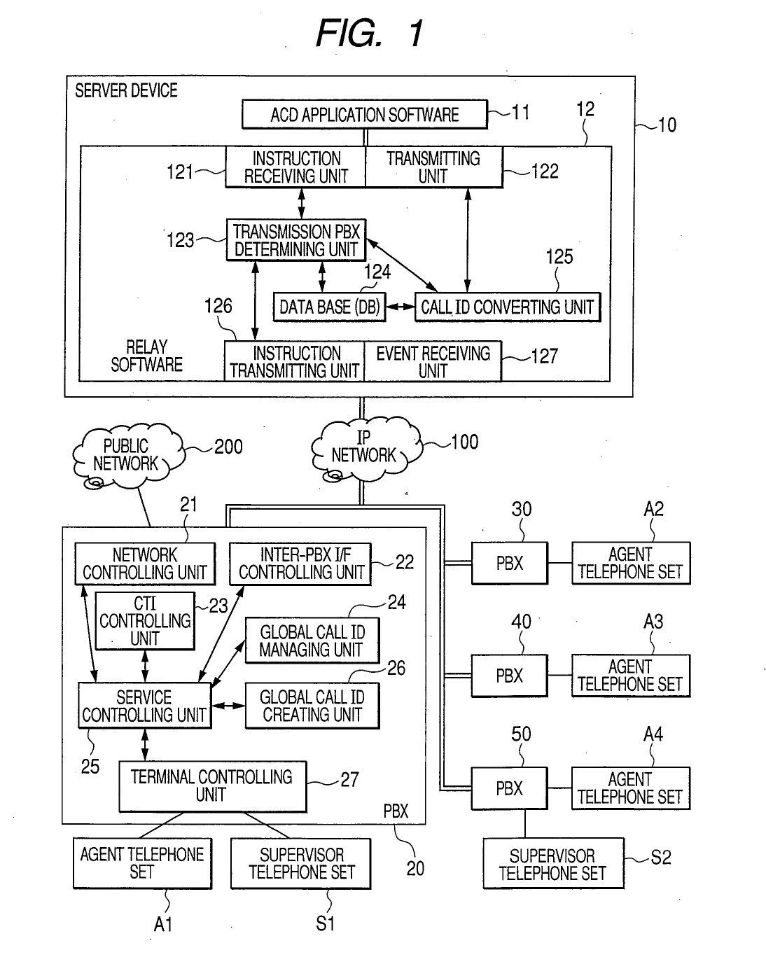

According to an embodiment, FIG. 1 shows an exemplary system diagram showing a telephone system. This system includes a plurality of PBXs 20, 30, 40 and 50 which are interconnected through an IP network 100. To the IP network 100, a server device 10 which is a main controller of call control is connected. The PBXs 20, 30, 40, 50 and server device 10 are interconnected under a known protocol by CTI control. The PBXs 20, 30, 40, 50 can execute mutual calling through the IP network 100 serving as a private network not via a public network.

Each PBX is connected with an agent telephone set serving as a communication terminal. The agent telephone sets A1 to A4 are connected to the PBXs 20, 30, 40, 50, respectively. A supervisor telephone set S1 is connected to the PBX 20. A supervisor telephone set S2 is connected to the PBX 50. The supervisor telephone set plays a role of an adviser or a supervisor for the agent telephone sets. The PBX 20 is connected to the public network 200 so that the mutual calling between each telephone set and the public network 200 is realized. Each PBX, when there is a call relative to the telephone set under itself, allots a call ID to the call. This local call ID is not necessarily recognizable in the other exchanges.

The PBX 20 includes a network controlling unit 21, an inter-PBX I/F (interface) controlling unit 22, a CTI controlling unit 23, a global call ID managing unit 24, a service controlling unit 25, a global call ID creating unit 26 and a terminal controlling unit 27. The PBXs 30, 40, 50 are also similar. The global call ID managing unit 24, service controlling unit 25 and global call ID creating unit 26, by their cooperative operation, gives a global call ID commonly used among the plurality of PBXs in the IP network 100 to each of the calls set through the IP network 100 among the different PBXs.

The server device 10 incorporates an ACD application software 11 and a relay software 12 having a function of the middleware between this application software 11 and the IP network 100. The relay software 12 incorporates an instruction receiving unit 121, an event transmitting unit 122, a transmission PBX determining unit 123, a data base (DB) 124, a call ID converting unit 125, an instruction transmitting unit 126 and an event receiving unit 127. Of these units, the call ID converting unit 125 converts the global call ID contained in a call processing event received from the IP network 100 through the event receiving unit 127 into the local call ID recognizable by the ACD application software 11. Inversely, the call ID converting unit 125 converts the local call ID contained in the call control information transmitted from the ACD application software 11 through the event transmitting unit 122 into the global call ID. In short, the call ID converting unit 125 correlates the global call ID and local call ID with each other.

The relay software 12 gives the local call ID created from the call ID converting unit 125 or the event having this local call to the ACD application software 11. The ACD application software 11 executes various controls relative to the call along a known processing procedure.

Next, an explanation will be given of the operation in the above configuration. Now, as an example, the explanation will be given of the call control procedure when the agent telephone set A1 (connected to the PBX 20) calls the agent telephone set A2 (connected to the PBX 30).

If the calling number for the agent telephone set A2 is inputted after off-hook of the agent telephone set A1, the PBX 20 requests the service controlling unit 25 to create a call on the basis of the data inputted from the terminal controlling unit 27. In creating a new call, the service controlling unit 25 requests the global call ID creating unit 26 to number a global call ID, thereby acquiring the global call ID. The service controlling unit 25 transfers the global call ID to the global call ID managing unit 24. The global call ID managing unit 24 holds this global call ID and manages it for call control instruction and event use.

Next, the service controlling unit 25 requests the inter-PBX I/F controlling unit 22 to create call control information to be transmitted to the PBX 30 and gives the inter-PBX I/F controlling unit 22 an instruction for adding the global call ID to this call control information. The PBX 30 having received the call control information via the IP network 100 acquires the global ID from the call control information, and sends to global call ID managing unit 24 an instruction for managing this global call ID.

Whenever a call and status transition of the agent occur in the service controlling unit 25, the CTI controlling unit 23 creates an event to be reported to the ACD application software 11. In this case, the CTI controlling unit 23 stores the global call ID presented from the service controlling unit 25 within this event and transmits this event to the server device 10 via the IP network 100.

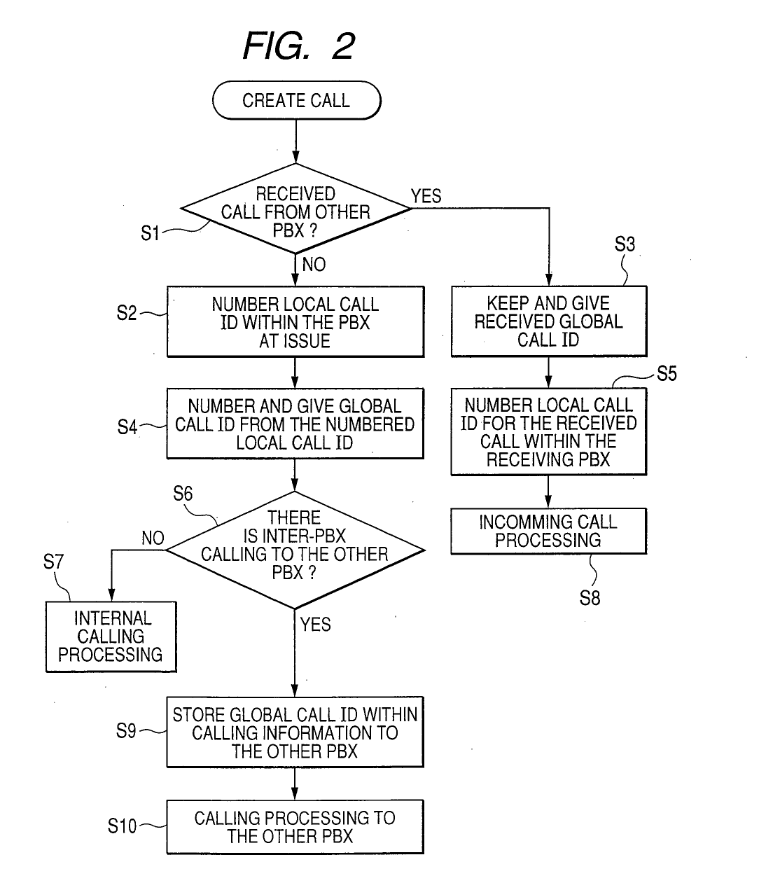

FIG. 2 shows an exemplary flowchart for explaining the processing procedure in numbering the global call ID in the PBX 20 in FIG. 1. The PBXs 30, 40, 50 also execute the same procedure. When a call is created, the PBX 20 determines if or not this call has been received from the other PBX (step S1). If Yes, the PBX 20 holds the global ID contained in the event relative to this call and gives this global call ID to the event (step S3). Next, the PBX 20 numbers the local call ID for the received call (step S5) and executes incoming call processing (step S8).

If the call at issue is a call occurred in the PBX 20 itself in step S1, the PBX 20 numbers the local call ID within itself (step S2), and numbers the global call ID corresponding to this local call ID and gives it to this call (step S4). In step S6, if the calling at issue is not the calling between the PBXs, the PBX 20 executes internal calling processing. If the calling at issue is the calling between the PBXs, the PBX 20 stores the global call ID in the calling information (event information) for a destination PBX (step S9) and thereafter executes the calling processing (step S10) for the destination PBX (step S10).

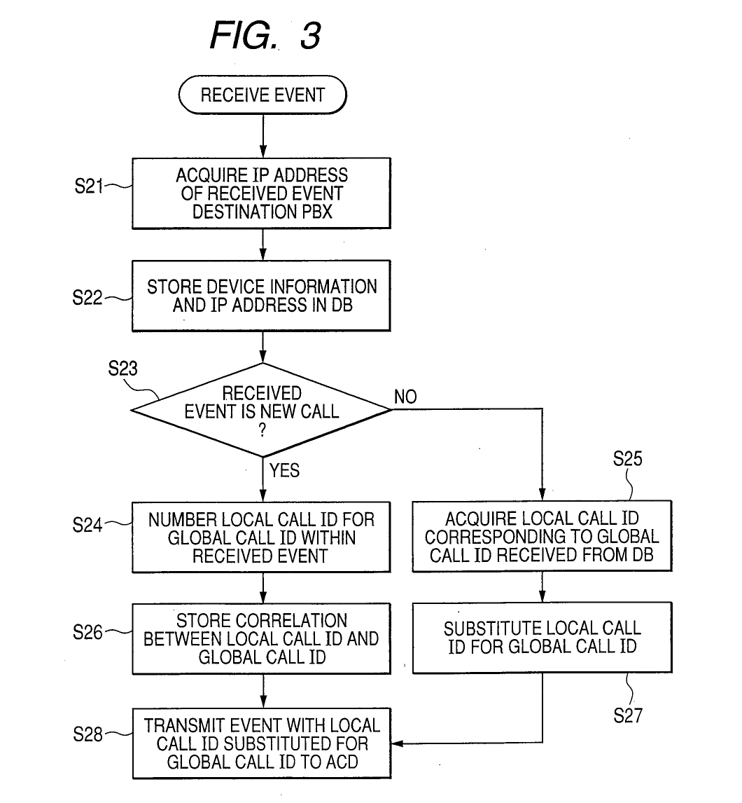

FIG. 3 shows an exemplary flowchart for explaining the processing procedure in converting the call ID in the relay software 12. In FIG. 3, when the relay software 12 acquires the event, it acquires the IP address of a transmission source PBX of this event from this event (step S21). This event also contains the device information of the transmission source PBX so that the relay software 12 stores, in the data base 24, this IP address as well as the device information as a set thereof (step S22). Next, the relay software 12 determines if or not the received event is new (step S23). If Yes, the relay software 12 numbers the local call ID corresponding to the global call ID within the received event (step S24), and stores the correlation between this local ID and the global ID in the data base (step S26). Further, the relay software 12 transmits, to the ACD application software 11, the event with the local call ID substituted for the global local ID (step S28).

If the received event is not new in step S23, the relay software 12, referring to the global call ID contained in the received event, acquires the local call ID corresponding to the event from the data base 124 (step S25). Further, the relay software 12 substitutes the local call ID for the global call ID of this event (step S27) and transmits this event to the ACD application software 11 (step S28).

The above procedure can be summarized as follows. Specifically, when the relay software 12 receives the event, it extracts the global ID within the event and converts this global ID into the local call ID to be used in the ACD application software 11. Next, the relay software 12 stores the local call ID after converted in the data base 124 so that it is correlated with the original global ID. Thus, in the relay software 12, mutual conversion between the local call ID and the global call ID is realized. The ID information is replaced within the event after converted into the local call ID, and the relay software 12 transmits this event to the ACD application software 11.

Inversely, the relay software 12 having received the call control instruction from the ACD application software 11 instructs the call ID converting unit 125 to convert the local call ID into the global call ID, thereby acquiring the global call ID for transmission to the PBX from the call ID converting unit 125. On the basis of the device information within the received call control instruction, the relay software 12 acquires the IP address to which the call control information is to be transmitted. If the IP address has been acquired, the relay software 12 transmits the call control instruction to the IP network 100. Each PBX controls the call on the basis of the developed result of the service control unit 25 according to the call control instruction from the ACD application software 11.

As described above, in this embodiment, in addition to the local call ID individually given for each call in each PBX, the global call ID which is commonly used between the exchanges is newly given. Within the IP network 100, the global call ID is given to the event relative to the call control so that the call control is executed. In the server device 10, the relay software 12 executes the mutual conversion between the global call ID and the local call ID so that the local call ID is sent to the ACD application software 11. Inversely, as regards the call control information from the ACD application software 11 based on the local call ID, the relay software 12 replaces its local call ID by the global call ID to be transmitted to the IP network 100.

Specifically, each PBX individually creates the local call ID for the call created and adds it to the event to be transmitted to the ACD application software 11. In this manner, in the calling between the PBXs, actually, the same call is handled as different two calls. In order to obviate such inconvenience, in this embodiment, the PBX which is a call creating source creates the global call ID in creating the call and informs a calling party PBX of the global call ID. The PBX which is a call receiving destination reports the event with the local call ID converted from the global call ID to the ACD application software 11. Thus, it is possible to cause the ACD application software to recognize a single call having a plurality of local call IDs as the same call.

The known ACD application software 11 can execute the management for the system having only a single PBX. On the other hand, the plurality of PBXs can be regarded as a single PBX by the ACD application software 11 according to the embodiment. Thus, as if the receivers allotted to a group of PBXs and calls occurring over the plurality of PBXs lie in the same PBX, the existing ACD application software 11 can be used as it is to execute the control management.

Since the existing application software can be used without adding any facility. When a receiver is arranged at a remote position occurs, the IP telephone set is accommodated via the network in the same PBX. Further, where the receivers are arranged in a remote wide range extending over the states like U.S.A., the IP telephone system is restricted by the numbering system of a PBX arrangement source and function setting of an accommodating destination. On the other hand, since the plurality of PBXs can be placed under the control of the ACD application software, a remote receiver can employ the function of a remote PBX. Thus, a business originating call can use the line of the accommodating PBX, and the calling charge can also be saved. Further, almost all the functions can be controlled on the single ACD application software, maintenance items such as addition of the receiver and group change of the receiver can be dealt with at one position so that the maintenance capability can also be enhanced. Accordingly, the calls created through the plurality of exchanges can be collectively managed. The convenience in using the ACD can be improved at low cost.

By preparing such a measure, a unique global call ID is given to each call. In the private network, each call is controlled on the basis of the global call ID. On the other hand, the ACD application software is given a local call ID converted from the global call ID so that an existing resource can be employed as it is. Further, since the plurality of exchanges can be regarded as a single exchange by the ACD application software, a troublesome processing procedure is not included in the ACD application software.

In addition, the plurality of exchanges can be managed/controlled by the existing ACD application software, and the calling between the exchanges can also controlled as the same call by the ACD application software. Further, no limitation is given to the arrangement of arrival trunks and receivers/managers so that a user's request can be flexibly dealt with. Furthermore, the number of arrival calls occurring over the exchanges can be easily counted so that the information on the function of the ACD application software can be correctly known.

According to the above-described embodiment, a telephone system can collectively manage calls formed through a plurality of exchanges at a low cost, thereby improving the convenience in using an ACD, and its call controlling method.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system comprising:
a plurality of exchanges interconnecting a private network each exchange including a plurality of communicating terminals and giving a local identifier to a call relative to each communication terminal belonging to each exchange;
a call control application unit configured to control the call based on the local identifier;
an identifier giving processing unit configured to give a global identifier commonly used among the plurality of exchanges to each call set among different exchanges through the private network;
a conversion processing unit configured to convert the global identifier into the local identifier recognizable by the call control application unit; and
a relay processing unit configured to give the converted local identifier to the call control application unit and enable the call control application unit to control a call having the global identifier based on the converted local identifier.

2. The telephone system according to claim 1, wherein the call control application unit is an automatic call distribution application software relative to the plurality of communicating terminals belonging to the telephone system.

3. The telephone system according to claim 1, wherein each exchange gives the global identifier to an event relative to a call control for the communicating terminals belonging to the exchange, and sends out the event toward the call control application unit.

4. A telephone system according to claim 1, wherein the relay processing unit converts the local identifier included in a call control information that is sent out from the call control application unit under the local identifier into a corresponding global identifier, and
wherein the relay processing unit relays the call control information including the corresponding global identifier to a destination exchange.

5. A telephone system according to claim 4, wherein the relay processing unit determines the destination exchange for the call control information based on a device information of the exchange included in an event information that generates the call control information.

6. A call control method for a telephone system including a plurality of exchanges interconnecting a private network each exchange including a plurality of communicating terminals and giving a local identifier to a call relative to each communication terminal belonging to each exchange, comprising:
giving a global identifier commonly used among the plurality of exchanges to each call set among different exchange through the private network;
converting the global identifier into the local identifier recognizable by a call control application unit configured to control the call based on the local identifier;
giving the converted local identifier to the call control application unit; and
controlling, by the call control application unit, a call having the global identifier based on the converted local identifier.

7. The call control method according to claim 6, wherein the call control application unit is an automatic call distribution application software relative to the plurality of communicating terminals belonging to the telephone system.

8. The call control method according to claim 6, comprising:
giving the global identifier to an event relative to a call control for the communicating terminals belonging to the exchange and sending out the event toward the call control application unit by each exchange.

9. The call control method according to claim 6, comprising:
converting, by a relay processing unit, the local identifier included in a call control information that is sent out from the call control application unit under the local identifier into a corresponding global identifier; and
relaying, by the relay processing unit, the call control information including the corresponding global identifier to a destination exchange.

10. The call control method according to claim 9, comprising:
determining, by the relay processing unit, the destination exchange for the call control information based on a device information of the exchange included in an event information that generates the call control information.

11. A computer program product for enabling a computer to control a call in a telephone system including a plurality of exchanges interconnecting a private network each exchange including a plurality of communicating terminals and giving a local identifier to a call relative to each communication terminal belonging to each exchange; comprising:
a call control application unit configured to control the call based on the local identifier;
an identifier giving processing unit configured to give a global identifier commonly used among the plurality of exchanges to each call set among different exchanges through the private network;
a conversion processing unit configured to convert the global identifier into the local identifier recognizable by the call control application unit; and
a relay processing unit configured to give the converted local identifier to the call control application unit and enable the call control application unit to control a call having the global identifier based on the converted local identifier.

12. The computer program product according to claim 11, wherein the call control application unit is an automatic call distribution application software relative to the plurality of communicating terminals belonging to the telephone system.

13. The computer program product according to claim 11, wherein the relay processing unit converts the local identifier included in a call control information that is sent out from the call control application unit under the local identifier into a corresponding global identifier, and
wherein the relay processing unit relays the call control information including the corresponding global identifier to a destination exchange.

14. The computer program product according to claim 13, wherein the relay processing unit determines the destination exchange for the call control information based on a device information of the exchange included in an event information that generates the call control information.
